(19) United States
(12) Patent Application Publication
(10) Pub. No.: US 2011/0135331 A1
(43) Pub. Date: Jun. 9, 2011

(54) IMAGE FORMING APPARATUS

(75) Inventor: Yoshihiro Mitsui, Numazu-shi (JP)

(73) Assignee: CANON KABUSHIKI KAISHA, Tokyo (JP)

(21) Appl. No.: 12/939,866

(22) Filed: Nov. 4, 2010

(30) Foreign Application Priority Data
Dec. 4, 2009 (JP) 2009-276831

(51) Int. Cl. G03G 15/08

(52) U.S. Cl. 399/53

(57) ABSTRACT

Provided is an image forming apparatus that can achieve a stable image quality from a leading-end side to a trailing-end side of an image when printing a high-density image on a transfer medium, regardless of the length of the transfer medium or the condition of the image forming apparatus.

### BACKGROUND OF THE INVENTION

1. Field of the Invention

The present invention relates to electrophotographic image forming apparatuses.

2. Description of the Related Art

When using a single-component nonmagnetic toner as a developer in a developing device used in an image forming apparatus, such as an electrophotographic photocopier or an electrophotographic printer, the developing device uses a developing roller for developing an electrostatic latent image on a photosensitive drum by supplying the toner thereto, and also uses a supplying roller capable of containing the toner in a foam layer thereof and provided for supplying the toner to the developing roller.

In such a developing device, when a large amount of toner is required for developing an image, such as when an image with a high print density is to be formed, the supplying roller can sometimes run short of toner to be supplied to the developing roller, possibly resulting in a low image density near the trailing end of a transfer medium in the conveying direction thereof.

In contrast, in Japanese Patent Laid-Open No. 10-260573, if the transfer medium has a predetermined length or greater and the print density is greater than or equal to a predetermined value, a bias voltage for biasing the toner from the supplying roller toward a region on the developing roller that corresponds to an image area near the trailing end of the transfer medium in the conveying direction is applied between the developing roller and the supplying roller so as to prevent the image area near the trailing end from becoming low in density.

However, even when a voltage that biases the toner toward the developing roller is applied between the supplying roller and the developing roller during image forming operation, as in Japanese Patent Laid-Open No. 10-260573, if the foam layer of the supplying roller does not contain enough toner, the advantage of suppressing reduction of image density near the trailing end of the transfer medium in the conveying direction is still difficult to achieve when a large amount of toner is required for developing the image.

### SUMMARY OF THE INVENTION

The present invention provides an image forming apparatus that can reduce the risk of a reduced image density occurring near the trailing end of a transfer medium in the conveying direction even when a large amount of toner is required for developing an image.

An image forming apparatus according to a first aspect of the present invention includes an image bearing member that bears an electrostatic latent image; a toner bearing member that bears and transports a toner so as to supply the toner to the electrostatic latent image; a toner supplying member having a foam layer on a surface thereof and configured to supply the toner to the toner bearing member, the toner being capable of entering and exiting the foam layer; an arithmetic portion that counts the number of print dots on the basis of image information for forming the electrostatic latent image; and an adjusting unit configured to adjust an amount of toner contained in the foam layer during a non-developing period. When the number of print dots is greater than or equal to a threshold value, the adjusting unit performs adjustment so as to increase the amount of toner contained in the foam layer relative to when the number of print dots is smaller than the threshold value.

With the first aspect of the present invention, when there is a possibility that a large amount of toner is required for developing an image, that is, when the number of print dots for image formation is greater than or equal to the threshold value, adjustment is performed so as to increase the amount of toner contained in the toner supplying member during the non-developing period. Thus, a sufficient amount of toner can be supplied from the toner supplying member to the toner bearing member during a developing period, thereby reducing the risk of a reduced image density occurring near the trailing end of a transfer medium in the conveying direction thereof.

An image forming apparatus according to a second aspect of the present invention includes an image bearing member that bears an electrostatic latent image; a toner bearing member that bears and transports a toner so as to supply the toner to the electrostatic latent image; a toner supplying member having a foam layer on a surface thereof and configured to supply the toner to the toner bearing member, the toner being capable of entering and exiting the foam layer; and an adjusting unit configured to adjust an amount of toner contained in the foam layer during a non-developing period. When a length of a transfer medium in a conveying direction thereof is greater than or equal to a threshold value, the adjusting unit performs adjustment so as to increase the amount of toner relative to when the length of the transfer medium is smaller than the threshold value.

With the second aspect of the present invention, when there is a possibility that a large amount of toner is required for developing an image, that is, when the length of the transfer medium in the conveying direction is greater than or equal to the threshold value, adjustment is performed so as to increase the amount of toner contained in the toner supplying member during the non-developing period. Thus, a sufficient amount of toner can be supplied from the toner supplying member to the toner bearing member during the developing period, thereby reducing the risk of a reduced image density occurring near the trailing end of the transfer medium in the conveying direction.

An image forming apparatus according to a third aspect of the present invention includes an image bearing member that bears an electrostatic latent image; a toner bearing member that bears and transports a toner so as to supply the toner to the electrostatic latent image; a toner supplying member having a foam layer on a surface thereof and configured to supply the toner to the toner bearing member, the toner being capable of entering and exiting the foam layer; an arithmetic portion that calculates a print density, which is a proportion of the number of print dots occupying the number of dots in a printable region, on the basis of image information for forming the electrostatic latent image; and an adjusting unit configured to adjust an amount of toner contained in the foam layer during a non-developing period. When the print density calculated by the arithmetic portion is greater than or equal to a threshold value, the adjusting unit performs adjustment so as to increase the amount of toner relative to when the calculated print density is smaller than the threshold value.

With the third aspect of the present invention, when there is a possibility that a large amount of toner is required for developing an image, that is, when the print density for image formation is greater than or equal to the threshold value, adjustment is performed so as to increase the amount of toner contained in the toner supplying member during the non-developing period. Thus, a sufficient amount of toner can be supplied from the toner supplying member to the toner bearing member during the developing period, thereby reducing the risk of a reduced image density occurring near the trailing end of the transfer medium in the conveying direction thereof.

Further features of the present invention will become apparent from the following description of exemplary embodiments with reference to the attached drawings.

### BRIEF DESCRIPTION OF THE DRAWINGS

FIG. 1 illustrates a developing device according to a first embodiment of the present invention.

FIGS. 2A to 2C are graphs showing the relationship between the amount of toner in a foam layer and the image density, used for explaining the first embodiment of the present invention.

FIG. 3 is a flow chart of a process based on the number of print dots, used for explaining the first embodiment of the present invention.

FIG. 4 is a flow chart of a process based on the length of a transfer medium and the print density, used for explaining the first embodiment of the present invention.

FIG. 5 is a flow chart of a process based on the number of print dots, used for explaining a second embodiment of the present invention.

FIG. 6 is a flow chart of a process based on the length of a transfer medium and the print density, used for explaining the second embodiment of the present invention.

FIG. 7 is a sequence chart illustrating the effect of changing a bias voltage applied to a supplying roller during a gap rotation period, used for explaining a third embodiment of the present invention.

FIG. 8 is a flow chart of a process based on the number of print dots, used for explaining the third embodiment of the present invention.

FIG. 9 is a flow chart of a process based on the length of a transfer medium and the print density, used for explaining the third embodiment of the present invention.

FIG. 10 is a flow chart of a process based on the number of print dots, used for explaining a fourth embodiment of the present invention.

FIG. 11 is a flow chart of a process based on the length of a transfer medium and the print density, used for explaining the fourth embodiment of the present invention.

FIG. 12 is a sequence chart illustrating a difference between continuous printing performed on banner paper and continuous printing performed on letter-size paper, used for explaining problems to be solved by the embodiments of the present invention.

### DESCRIPTION OF THE EMBODIMENTS

### First Embodiment

In a first embodiment of the present invention, reduction of image density near the trailing end of a sheet of paper, acting as a transfer medium, in the conveying direction thereof is prevented by extending the rotation period of a supplying roller between a current sheet and a subsequent sheet (i.e., a period equivalent to a gap between a current transfer medium and a subsequent transfer medium) during continuous printing in accordance with the number of print dots obtained from image information (i.e., the counted number of signals corresponding to print dots in an image signal) or in accordance with the length of the sheet and the print density (i.e., a proportion of the number of print dots occupying the number of dots in a printable region).

An exemplary embodiment of the present invention will be described in detail below with reference to the drawings. It should be noted that the dimensions, materials, shapes, and relative arrangements of components described in this embodiment are modifiable depending on various conditions and device configurations to which the invention is applied, and are not intended to limit the scope of the invention to the following embodiment.

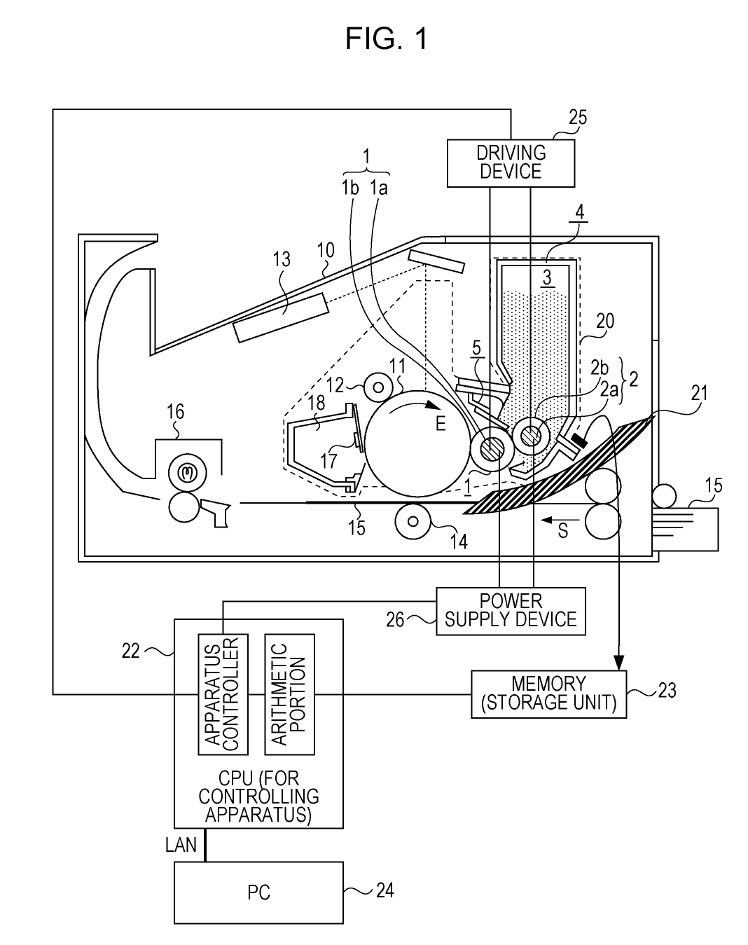

FIG. 1 is a schematic cross-sectional view of an image forming apparatus body 10 according to the first embodiment of the present invention. In this embodiment, a developing device 4, a photosensitive drum 11, a charging roller 12, a cleaning blade 17, and a waste-toner container 18 are disposed as a single-unit cartridge 20 in a detachable manner in the image forming apparatus body 10.

In FIG. 1, the photosensitive drum 11 serving as an image bearing member rotates in a direction indicated by an arrow E. First, the photosensitive drum 11 is negatively charged uniformly by the charging roller 12 serving as a charging device. Then, the photosensitive drum 11 is exposed to laser light from a laser optical device 13 serving as an exposure unit, whereby an electrostatic latent image is formed on a surface of the photosensitive drum 11.

This electrostatic latent image is developed by the developing device 4 so as to be made visible as a toner image. In this embodiment, a toner is adhered to the exposed section of the photosensitive drum 11, whereby the toner image is reversely developed.

The visible toner image on the photosensitive drum 11 is transferred by a transfer roller 14 onto a transfer medium 15 conveyed in a direction indicated by an arrow S in FIG. 1. The untransferred toner remaining on the photosensitive drum 11 is scraped off therefrom by the cleaning blade 17 serving as a cleaning member and is received and held by the waste-toner container 18. The cleaned photosensitive drum 11 repeats the above-described operation so that image forming operation is performed. On the other hand, the toner image transferred on the transfer medium 15 is permanently fixed thereon by a fixing device 16 before the transfer medium 15 is ejected outward from the apparatus.

Next, the developing device 4 will be described with reference to FIG. 1.

The developing device 4 includes a developer container 3, a developing roller 1 serving as a toner bearing member, a supplying roller 2 serving as a toner supplying member, and a toner regulation member 5. Regarding the toner used for developing the electrostatic latent image, the charge polarity of a major portion thereof is defined as a normal charge polarity. In this embodiment, a toner T having a negative charge polarity as the normal charge polarity is used.

The developing roller 1 is disposed at an opening of the developer container 3 and is rotatably supported by the developer container 3. The developing roller 1 includes an electrically conductive shaft (first electrode member) 1a composed of stainless steel or an aluminum alloy, and an electrically-conductive elastic layer 1b formed therearound and having a silicon rubber layer as its base layer. The developing roller 1 bears and transports the toner so as to supply the toner to the electrostatic latent image on the photosensitive drum 11.

The supplying roller 2 is disposed in contact with the developing roller 1 within the developer container 3. The supplying roller 2 is configured to supply the toner to the developing roller 1 and includes an electrically conductive shaft (second electrode member) 2a composed of stainless steel or an aluminum alloy, and a urethane sponge layer (foam layer) 2b formed therearound. The toner is capable of entering and exiting the urethane sponge layer 2b. The urethane sponge layer 2b is provided on a surface of the supplying roller 2. Furthermore, the toner regulation member 5 whose one end abuts on the developing roller 1 so as to control the toner T supplied to the developing roller 1 to a thin layer is disposed in the developer container 3. The developing roller 1 and the supplying roller 2 are rotationally driven by a driving device 25.

The developing device 4 is provided with a storage unit 23. The storage unit 23 may be of a freely-chosen type including, for example, a contact-type nonvolatile memory, a noncontact-type nonvolatile memory, or a volatile memory having a power source. In this embodiment, a noncontact-type nonvolatile memory 23 is mounted as the storage unit in the cartridge 20. The noncontact-type nonvolatile memory 23 has an antenna (not shown) serving as a memory-side information transmitter and wirelessly communicates with a CPU 22 serving as a controller included in the image forming apparatus body 10 so as to be capable of reading and writing information.

In this embodiment, the CPU 22 includes a control portion, an arithmetic portion, a storage portion (ROM), and a clock, and also has a function of reading and writing information from and onto the storage unit 23 via an apparatus-side information transmitter.

The arithmetic portion is capable of counting and calculating the number of print dots and the print density ((the number of print dots)/(the number of dots in a printable region)) within a single image on the basis of image information transmitted from a personal computer (PC) 24. By sending the information to an apparatus controller before or while the image forming apparatus performs printing operation, the operation of the image forming apparatus can be feed-forward-controlled on the basis of the information.

In this embodiment, the storage unit 23 stores the result of the remaining amount of toner estimated on the basis of the number of print dots.

In this embodiment, when printing is to be performed on a transfer medium having a different length in the conveying direction, the length of the transfer medium is freely selected in advance on the PC 24, and the information is transmitted to the apparatus controller.

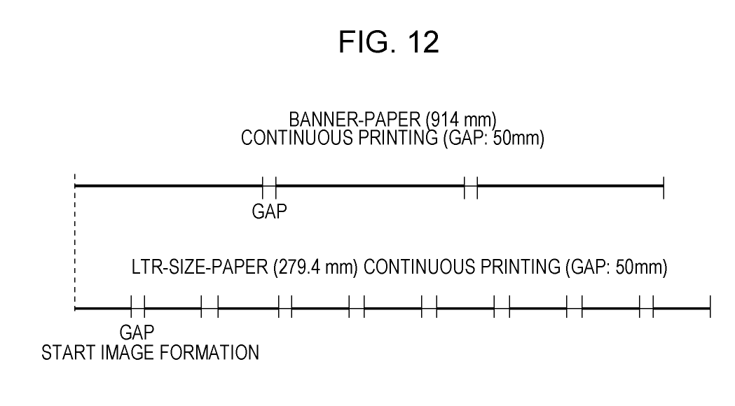

When such an image forming apparatus prints an image with a high print density onto a transfer medium, such as banner paper (914 mm×210 mm), having a length, in the conveying direction, greater than the lengthwise dimension of A4-size paper (297 mm×210 mm) or the lengthwise dimension of letter-size paper (279.4 mm×216 mm), the trailing-end side of the image tends to be lower in density. This tendency of the trailing-end side of the image being lower in density is prominent especially when continuous printing is performed. FIG. 12 illustrates a sequence chart obtained when continuous printing is performed on letter-size paper and banner paper at the same time. Comparing the two kinds of paper within a certain segment, the number of times the developing device 4 is rotationally driven without consuming toner in a gap between a current transfer medium and a subsequent transfer medium (this operation will be referred to as “gap rotation” hereinafter) is smaller for the continuous printing performed on the banner paper. Because the supplying roller 2 takes in toner into its foam layer from its periphery by rotating, if the supplying roller 2 is rotationally driven during a non-developing period in which toner is not consumed (a period in which a developing process is performed by supplying the toner from the developing roller 1 to the photosensitive drum 11 will be referred to as “developing period”, whereas a period in which the developing process is not performed will be referred to as “non-developing period”), the supplying roller 2 would take in the toner toward an amount with which the supplying roller 2 can be saturated. Since gap rotation is performed in a non-developing period, when continuous printing is to be performed on banner paper, in which gap rotation is performed less frequently, the number of times the toner is taken into the foam layer is relatively small. In addition, because the toner is consumed in the developing process, the toner around the supplying roller 2 temporarily decreases, causing the amount of toner contained in the supplying roller 2 to become relatively small. Therefore, it is conceivable that the trailing-end side of the image tends to become lower in density.

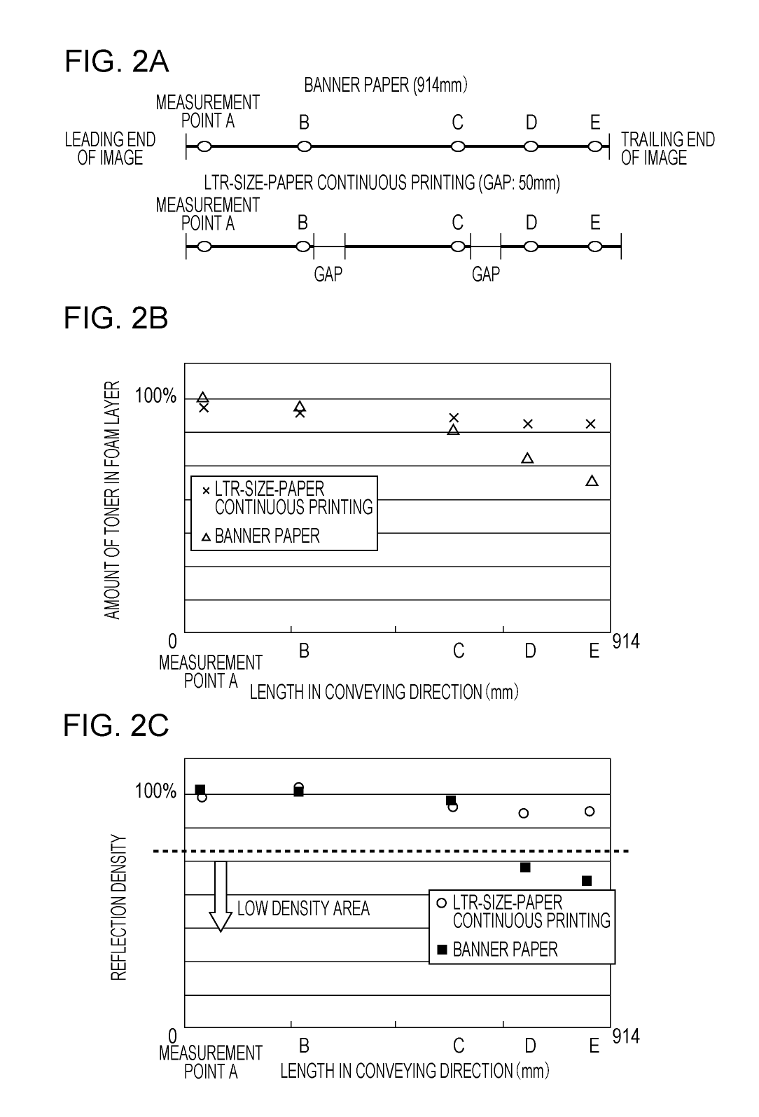

In light of this, the present inventor has conducted a verification experiment on banner paper as an example for clarifying the relationship between a reduced image density and the amount of toner in the foam layer. FIGS. 2A to 2C illustrate the experimental results.

The experiment was commenced under a preset condition in which reduction of image density would occur at the trailing-end side of an image when a solid image is printed on a single sheet of banner paper. Specifically, after printing a full white image onto ten sheets of letter-size paper and soaking the foam layer with a sufficient amount of toner, printing was performed on a single sheet of banner paper to reduce the toner in the foam layer, and then the experiment was commenced immediately after obtaining this state. In the experiment, the printing operation was stopped at a position corresponding to a measurement point A in the conveying direction of the single sheet of banner paper shown in FIG. 2A. The supplying roller 2 was removed from the developing device 4 so that the amount of toner in the foam layer can be measured. The result obtained is shown in FIG. 2B. In FIGS. 2A to 2C, the amount of toner in the foam layer at the point of commencement of the experiment is defined as 100%. At the same time, the solid image at the toner-amount measurement point A was fixed to the sheet, and the reflection density thereof was measured by using a reflection densitometer (Macbeth RD918). The reflection density at the point of commencement of the experiment is also defined as 100%. The result obtained is shown in FIG. 2C. After repeating this operation under the aforementioned condition for every measurement point shown in FIG. 2A, measurement results of the reflection density and the amount of toner in the foam layer at each measurement point in the conveying direction were obtained. These measurement results are shown in FIGS. 2B and 2C.

As a comparison, continuous printing of a solid image was performed on letter-size paper under the same condition, and the same measurement was performed at a timing corresponding to each measurement point shown in FIG. 2A, whereby measurement results of the amount of toner in the foam layer and the reflection density were obtained. These measurement results are shown in FIGS. 2B and 2C.

It is apparent from FIG. 2B that the amount of toner in the foam layer consistently decreases from the leading-end side toward the trailing-end side of the image in the case of the printing performed on banner paper. It is apparent from the relationship between the amount of toner in the foam layer shown in FIG. 2B and the density of the solid image shown in FIG. 2C that the density of the solid image significantly decreases when the amount of toner in the foam layer is smaller than or equal to a certain value.

On the other hand, in the case of the continuous printing performed on letter-size paper as a comparison, the amount of toner in the foam layer slightly decreases from the start of the printing operation but substantially converges on a certain value.

Comparing the two kinds of printing, the number of times gap rotation is performed, that is, the number of times the developing device is rotationally driven without consuming toner between the current transfer medium and the subsequent transfer medium, is greater in the continuous printing performed on letter-size paper. Therefore, the number of times the toner is supplied to the foam layer is relatively greater, meaning that the amount of toner held and maintained by the supplying roller is relatively greater. It is thus conceivable that reduction of image density is less likely to occur than when the printing is performed on banner paper.

On the other hand, in the case of the printing performed on the banner paper, since the toner is consumed continuously by a large amount, the foam layer cannot be filled with the toner in time. It is thus conceivable that the amount of toner in the foam layer relatively decreases to a level that causes a reduced image density to occur. In such a state where the amount of toner in the foam layer is decreased, even if a bias voltage for biasing the toner is applied from the supplying roller toward the developing roller during the image forming operation, as discussed in Japanese Patent Laid-Open No. 10-260573, the advantage of suppressing reduction of image density is still difficult to achieve when a large amount of toner is required for developing the image.

In light of this, the present inventor has conceived that, when a high-density image is to be printed onto a transfer medium that is long in the conveying direction, such as banner paper, providing an adjusting unit that performs adjustment so as to increase the amount of toner contained in the foam layer during the non-developing period is effective for reducing the risk of a reduced image density at the trailing-end side of an image, which can occur due to decreased toner in the foam layer. When a predetermined condition is satisfied, the adjusting unit in this embodiment is configured to perform adjustment so as to increase the amount of toner contained in the foam layer by extending the gap rotation period relative to when the predetermined condition is not satisfied.

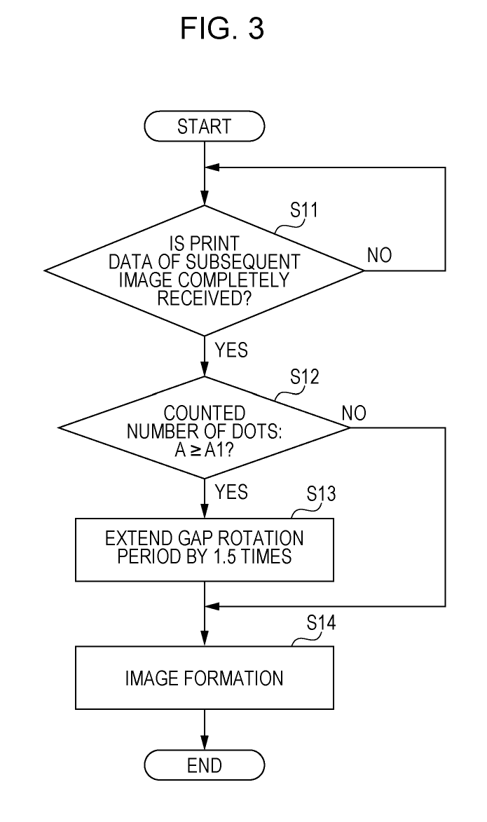

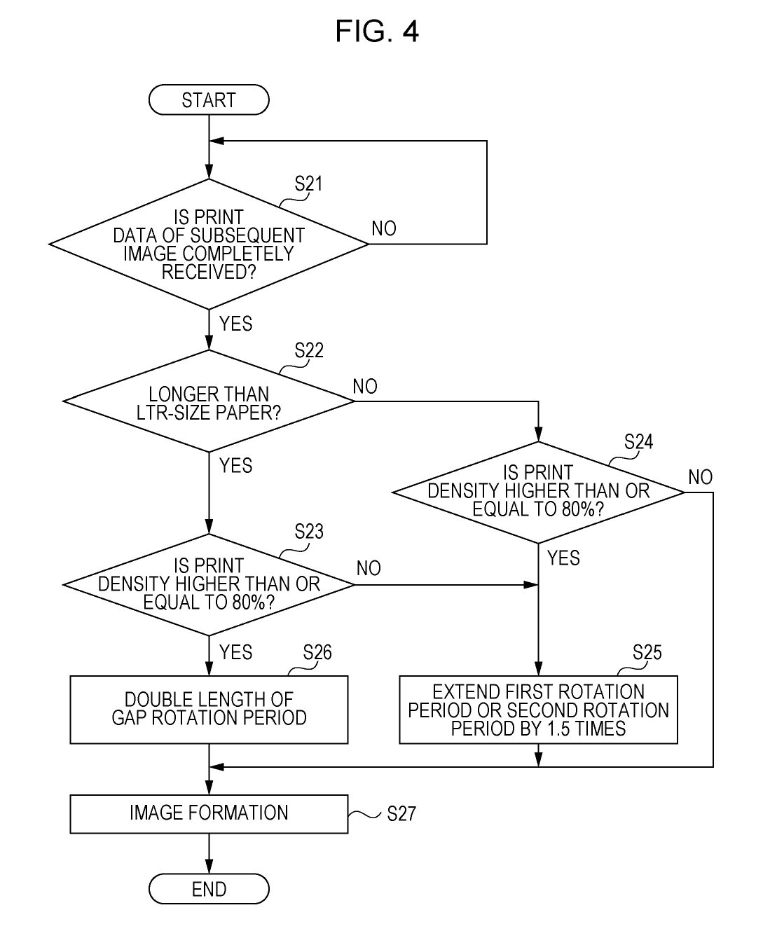

A sequence that uses the number of print dots of a print image as an indicator for estimating the aforementioned risk and a sequence that uses the length of a transfer medium in the conveying direction and the print density will now be described with reference to flow charts shown in FIGS. 3 and 4.

In the following sequences, an indicator value for estimating the aforementioned risk is set so as not only to reduce the risk of a reduced image density occurring at the aforementioned level, but also to acquire a high-quality image with a more stable image density.

### Sequence Using the Number of Print Dots as Indicator (FIG. 3)

When the sequence commences, it is determined in step S11 whether print data of a subsequent image is completely received. In step S12, it is determined whether the number of print dots A for each image of a print job is greater than or equal to the number of print dots A1 corresponding to 80% of the print density of letter-size paper. If greater than or equal to the value A1, the process proceeds to step S13. If smaller than the value A1, the process proceeds to step S14. In step S13, the gap rotation period is extended by 1.5 times. In step S14, image forming operation is carried out.

In such a sequence that uses the number of print dots as the indicator for estimating the aforementioned risk, since the amount of toner required for developing a target image is substantially proportional to the number of print dots, an appropriate threshold value is set for the number of print dots. If the number of print dots is greater than or equal to the threshold value, the gap rotation period is extended relative to when the number of print dots is smaller than the threshold value, so that the risk of a reduced image density occurring at the trailing-end side of the image can be reduced.

### Sequence Using Length of Transfer Medium in Conveying Direction and Print Density as Indicators (FIG. 4)

When the sequence commences, it is determined in step S21 whether print data of a subsequent image is completely received. In step S22, it is determined whether the length of a transfer medium for each image of a print job is greater than the length of letter-size paper. If longer than letter-size paper, the process proceeds to step S23. If shorter than or the same length as letter-size paper, the process proceeds to step S24. In step S23, it is determined whether the print density of each image of the print job is higher than or equal to 80%. If higher than or equal to 80%, the process proceeds to step S26. If lower than 80%, the process proceeds to step S25. In step S24, it is determined whether the print density of each image of the print job is higher than or equal to 80%. If higher than or equal to 80%, the process proceeds to step S25. If lower than 80%, the process proceeds to step S27. In step S25, the gap rotation period is extended by 1.5 times. In step S26, the length of the gap rotation period is doubled. In step S27, image forming operation is carried out.

In such a sequence that uses the length of the transfer medium in the conveying direction and the print density as the indicators for estimating the aforementioned risk, a possibility that the amount of toner required for developing a target image increases becomes higher with increasing length of the transfer medium in the conveying direction or increasing print density. Therefore, appropriate threshold values are set for the length of the transfer medium in the conveying direction and the print density. If greater than or equal to the respective threshold values, the gap rotation period is extended relative to when the length of the transfer medium in the conveying direction and the print density are smaller than the threshold values, so that the risk of a reduced image density occurring at the trailing-end side of the image can be reduced. In that case, since the length of the transfer medium in the conveying direction and the print density are independent of each other as the indicators for estimating the aforementioned risk, the gap rotation period is extended if one of the indicators is greater than or equal to the corresponding threshold value, and if both indicators are greater than or equal to the respective threshold values, the gap rotation period is further extended relative to when only one of the indicators is greater than or equal to the corresponding threshold value, as shown in the sequence in FIG. 4, thereby advantageously reducing the risk of a reduced image density occurring at the trailing-end side of the image. The reason is because, despite the transfer medium being long in the conveying direction, only a small amount of toner is required for developing an image if the print density is low, and likewise, despite the print density being high, only a small amount of toner is required for developing an image if the transfer medium is short in the conveying direction. Therefore, by using both of these two indicators, the two indicators can complement each other so that the aforementioned advantage can be further achieved. On the other hand, although the aforementioned risk can be effectively reduced by using the number of print dots as a single indicator since the number of print dots is substantially proportional to the amount of toner required for developing an image, as shown in the sequence in FIG. 3, the single indicator may alternatively be combined with another indicator, as in FIG. 4.

A value used as a reference for determining whether to extend the gap rotation period in this embodiment is changeable where appropriate depending on the embodiment. Although a mode in which the image information is transmitted from the PC 24 is described in this embodiment, the invention is not limited to this mode so long as the mode utilizes image information based on which the number of print dots can be counted. Furthermore, although the number of print dots for forming a single image is used as the indicator for estimating the aforementioned risk in this embodiment, the number of print dots for forming multiple images may alternatively be used so that a long-term risk can be estimated and reduced.

### Second Embodiment

In a second embodiment of the present invention, an adjusting unit similar to that in the first embodiment performs adjustment so as to increase the amount of toner contained in the foam layer by extending a first rotation period or a second rotation period instead of extending the gap rotation period during continuous printing, thereby preventing the occurrence of a reduced image density at the trailing-end side of an image. In this case, the term “first rotation period” refers to a period between a point at which the supplying roller 2 starts rotating and a point at which a developing process commences (i.e., a process of supplying toner from the developing roller 1 to the photosensitive drum 11) when image forming operation is performed, whereas the term “second rotation period” refers to a period between a point at which the developing process is completed and a point at which the supplying roller 2 stops rotating.

The image forming apparatus according to this embodiment has the same configuration as that of the image forming apparatus according to the first embodiment.

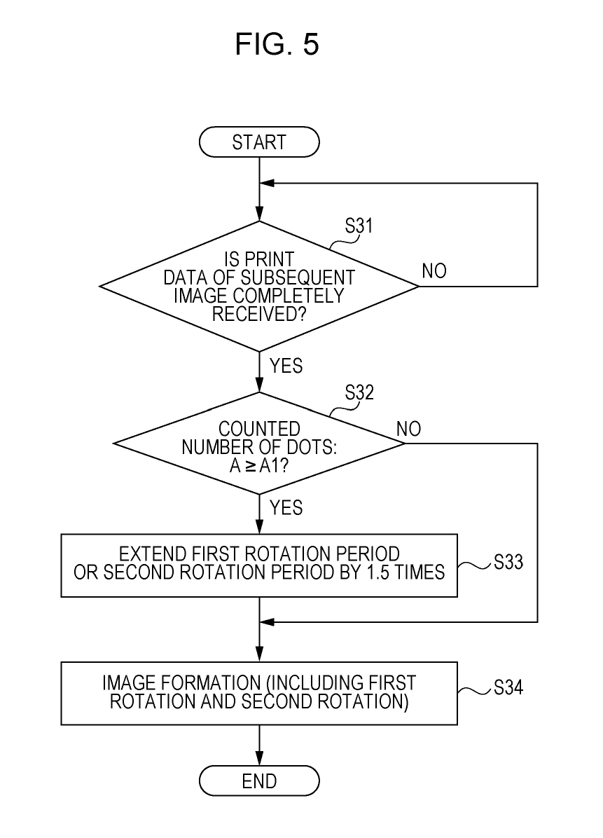

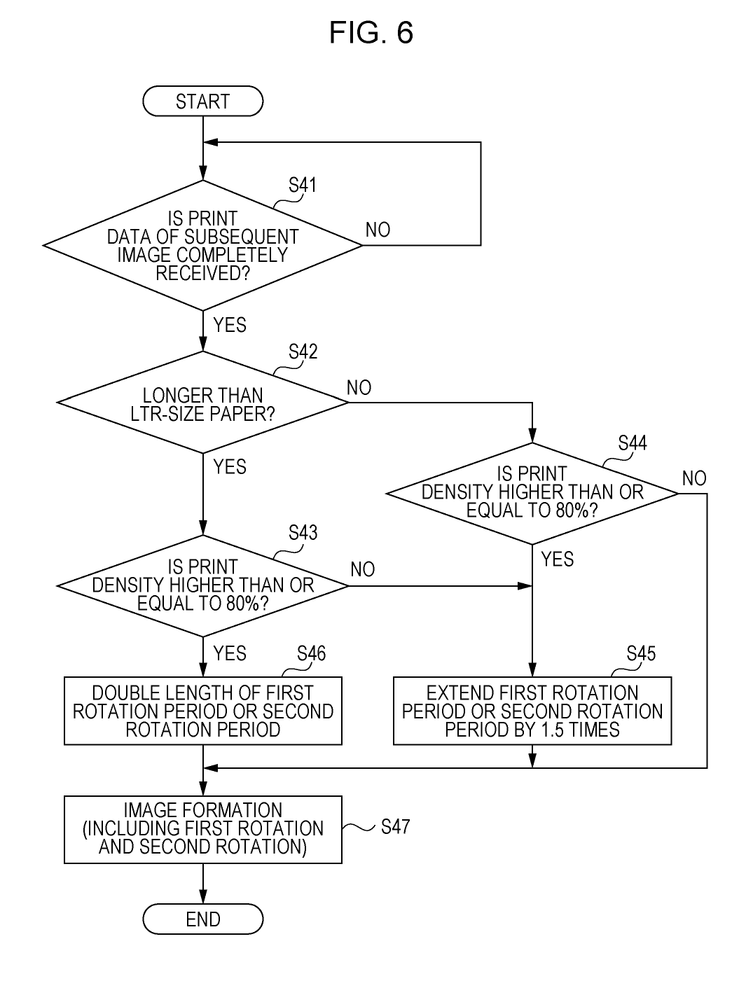

Similar to the first embodiment, in order to estimate the risk of a reduced image density occurring at the trailing-end side of the image, which can occur due to decreased toner in the foam layer, a sequence that uses the number of print dots as an indicator and a sequence that uses the length of a transfer medium and the print density as indicators will now be described with reference to flow charts shown in FIGS. 5 and 6.

### Sequence Using the Number of Print Dots as Indicator (FIG. 5)

When the sequence commences, it is determined in step S31 whether print data of a subsequent image is completely received. In step S32, it is determined whether the number of print dots A for each image of a print job is greater than or equal to the number of print dots A1 corresponding to 80% of the print density of letter-size paper. If greater than or equal to the value A1, the process proceeds to step S33. If smaller than the value A1, the process proceeds to step S34. In step S33, the first rotation period or the second rotation period is extended by 1.5 times. In step S34, image forming operation (including first rotation and second rotation) is carried out.

### Sequence Using Length of Transfer Medium and Print Density as Indicators (FIG. 6)

When the sequence commences, it is determined in step S41 whether print data of a subsequent image is completely received. In step S42, it is determined whether the length of a transfer medium for each image of a print job is greater than the length of letter-size paper. If longer than letter-size paper, the process proceeds to step S43. If shorter than or the same length as letter-size paper, the process proceeds to step S44. In step S43, it is determined whether the print density of each image of the print job is higher than or equal to 80%. If higher than or equal to 80%, the process proceeds to step S46. If lower than 80%, the process proceeds to step S45. In step S44, it is determined whether the print density of each image of the print job is higher than or equal to 80%. If higher than or equal to 80%, the process proceeds to step S45. If lower than 80%, the process proceeds to step S47. In step S45, the first rotation period or the second rotation period is extended by 1.5 times. In step S46, the length of the first rotation period or the second rotation period is doubled. In step S47, image forming operation (including first rotation and second rotation) is carried out.

Similar to the first embodiment, the second embodiment can advantageously reduce the risk of a reduced image density occurring at the trailing-end side of the image. In particular, the following advantages can be achieved when the first rotation period is extended and when the second rotation period is extended.

The control for extending the first rotation period is performed so that the supplying roller 2 can hold a sufficient amount of toner. Thus, for example, the effect of a decreased amount of toner held in the foam layer occurring with printing operation prior to performing printing on banner paper can be cancelled, and the supplying roller 2 can hold a sufficient amount of toner prior to the printing operation to be performed on banner paper, thereby reducing the risk of a reduced image density occurring in the image forming operation to be performed immediately after the first rotation.

Regarding the control for extending the second rotation period, because the amount of toner in the foam layer is decreased upon completion of the printing operation performed on, for example, banner paper, the control is performed so that the foam layer is sufficiently soaked with toner during the second rotation. Thus, the risk of a reduced image density occurring in the image forming operation to be performed on letter-size paper immediately after the printing operation performed on, for example, banner paper can be reduced.

Although the aforementioned risk can be effectively reduced by using the number of print dots as a single indicator since the number of print dots is substantially proportional to the amount of toner required for developing an image, as shown in the sequence in FIG. 5, the single indicator may alternatively be combined with another indicator, as in FIG. 6. Although predetermined values are used as references for determining whether to extend the first rotation period and the second rotation period in this embodiment, the values are changeable where appropriate depending on the embodiment. Furthermore, although the print density and the length of the transfer medium in the conveying direction for forming a single image are used as the indicators for estimating the aforementioned risk in this embodiment, the total length of the transfer medium in the conveying direction corresponding to multiple images or the overall print density of the multiple images may alternatively be used so that a long-term risk can be estimated and reduced.

### Third Embodiment

In a third embodiment of the present invention, instead of extending the gap rotation period during continuous printing, an adjusting unit similar to that in the first embodiment controls a potential difference between a bias voltage applied to the shaft 1a (first electrode member) of the developing roller 1 and a bias voltage applied to the shaft 2a (second electrode member) of the supplying roller 2 during the gap rotation period in continuous printing so that the toner is biased from the developing roller 1 toward the supplying roller 2, thereby preventing the occurrence of a reduced image density.

The image forming apparatus according to this embodiment has a similar configuration to that of the image forming apparatus according to the first embodiment shown in FIG. 1, and uses a power supply device 26 as a voltage applying unit that applies voltage to the shaft 1a and the shaft 2a so as to increase the amount of toner contained in the foam layer. The advantage of controlling the potential difference between the bias voltage applied to the shaft 1a and the bias voltage applied to the shaft 2a so that the toner is biased from the developing roller 1 toward the supplying roller 2 during the gap rotation period will be described below in comparison to a comparative example.

In both the comparative example and the present embodiment, a solid image is printed in a continuous mode onto multiple sheets of banner paper. In the comparative example, the electric potential for the shaft 1a and the electric potential for the shaft 2a corresponding to the gap between a current sheet and a subsequent sheet are set to the same value, which is a normal bias voltage.

On the other hand, in this embodiment, the potential difference between the shaft 1a and the shaft 2a corresponding to the gap between a current sheet and a subsequent sheet is set such that a value obtained by subtracting the electric potential for the shaft 1a from the electric potential for the shaft 2a is equal to +100 V, so that the toner T with a negative charge polarity is biased from the developing roller 1 toward the supplying roller 2. By setting the respective voltages so that the value obtained by subtracting the electric potential applied to the shaft 1a from the electric potential applied to the shaft 2a has a polarity opposite of the normal charge polarity of the toner, the toner can be biased from the developing roller 1 toward the supplying roller 2.

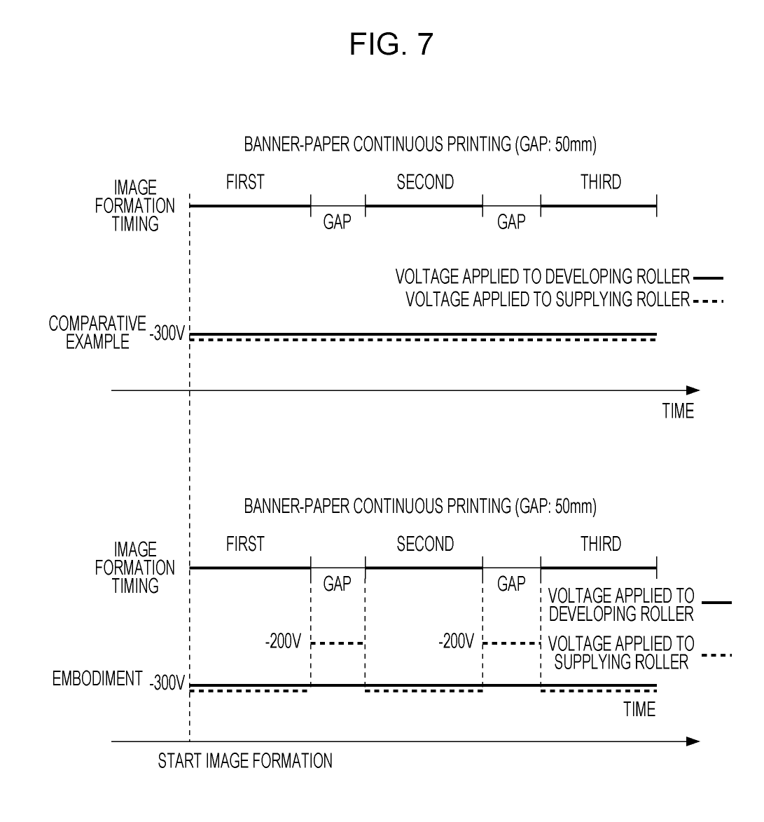

FIG. 7 illustrates the relationship between the voltage applied to the shaft 2a and the voltage applied to the shaft 1a in the comparative example and the present embodiment. In the comparative example, the reflection density significantly decreases from the trailing-end side of a second image in continuous printing shown in FIG. 7. On the other hand, in the present embodiment, even when printing operation is repeatedly performed in a continuous mode on banner paper, a certain image density or higher can be maintained to the trailing end of the transfer medium.

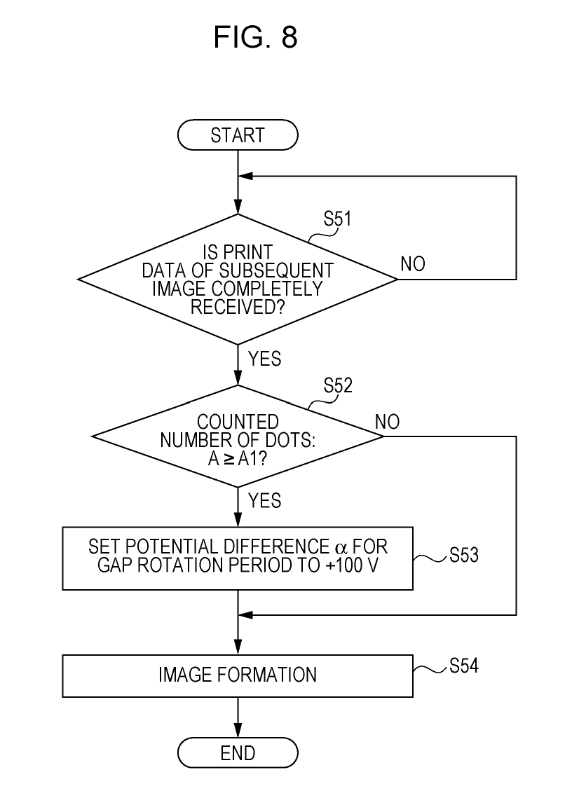

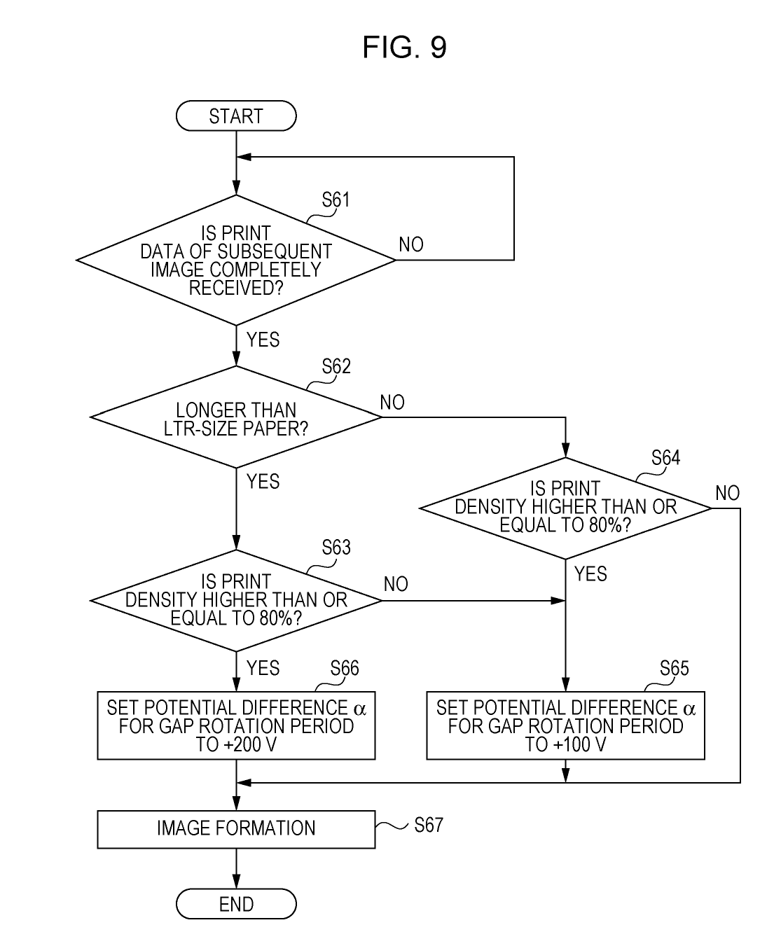

Similar to the first embodiment, in order to estimate the risk of a reduced image density occurring at the trailing-end side of the image, which can occur due to decreased toner in the foam layer, a sequence that uses the number of print dots as an indicator and a sequence that uses the length of a transfer medium and the print density as indicators will now be described with reference to flow charts shown in FIGS. 8 and 9.

### Sequence Using the Number of Print Dots as Indicator (FIG. 8)

When the sequence commences, it is determined in step S51 whether print data of a subsequent image is completely received. In step S52, it is determined whether the number of print dots A for each image of a print job is greater than or equal to the number of print dots A1 corresponding to 80% of the print density of letter-size paper. If greater than or equal to the value A1, the process proceeds to step S53. If smaller than the value A1, the process proceeds to step S54. In step S53, a potential difference α between the shaft 2a and the shaft 1a for the gap rotation period is set to +100 V. In step S54, image forming operation is carried out.

### Sequence Using Length of Transfer Medium and Print Density as Indicators (FIG. 9)

When the sequence commences, it is determined in step S61 whether print data of a subsequent image is completely received. In step S62, it is determined whether the length of a transfer medium for each image of a print job is greater than the length of letter-size paper. If longer than letter-size paper, the process proceeds to step S63. If shorter than or the same length as letter-size paper, the process proceeds to step S64. In step S63, it is determined whether the print density of each image of the print job is higher than or equal to 80%. If higher than or equal to 80%, the process proceeds to step S66. If lower than 80%, the process proceeds to step S65. In step S64, it is determined whether the print density of each image of the print job is higher than or equal to 80%. If higher than or equal to 80%, the process proceeds to step S65. If lower than 80%, the process proceeds to step S67. In step S65, the potential difference α between the shaft 2a and the shaft 1a for the gap rotation period is set to +100 V. In step S66, the potential difference α between the shaft 2a and the shaft 1a for the gap rotation period is set to +200 V. In step S67, image forming operation is carried out.

Similar to the first embodiment, the third embodiment can advantageously reduce the risk of a reduced image density occurring at the trailing-end side of the image and can also soak the supplying roller 2 with the toner within a shorter time due to the bias application.

Although the aforementioned risk can be effectively reduced by using the number of print dots as a single indicator since the number of print dots is substantially proportional to the amount of toner required for developing an image, as shown in the sequence in FIG. 8, the single indicator may alternatively be combined with another indicator, as in FIG. 9. Although a predetermined value is used as a reference for determining whether to apply a voltage for soaking the supplying roller 2 with the toner in this embodiment, the value is changeable where appropriate depending on the embodiment. Furthermore, although the number of print dots for forming a single image is used as the indicator for estimating the aforementioned risk in this embodiment, the number of print dots for forming multiple images may alternatively be used so that a long-term risk can be estimated and reduced. If it is determined that there is a risk of the occurrence of a reduced image density in the sequences in FIGS. 8 and 9 (i.e., when each indicator exceeds a corresponding threshold value), the bias application according to this embodiment and the extension of the gap rotation period according to the first embodiment may both be performed.

### Fourth Embodiment

In a fourth embodiment of the present invention, an adjusting unit similar to that in the third embodiment controls a potential difference between a bias voltage applied to the shaft 1a of the developing roller 1 and a bias voltage applied to the shaft 2a of the supplying roller 2 during the first rotation period or the second rotation period instead of during the gap rotation period in continuous printing so that the toner is biased from the developing roller 1 toward the supplying roller 2, thereby preventing the occurrence of a reduced image density at the trailing-end side of an image.

The image forming apparatus according to this embodiment has a similar configuration to that of the image forming apparatus according to the third embodiment.

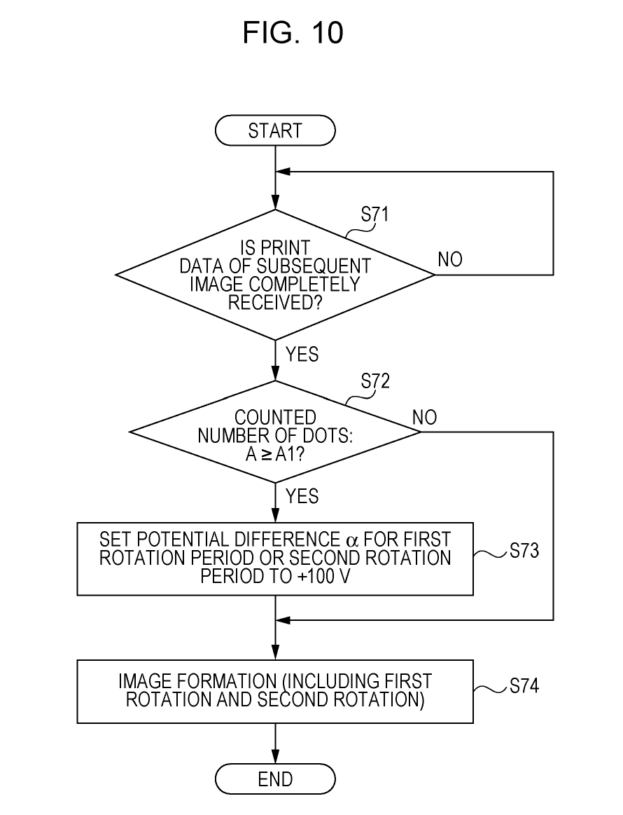

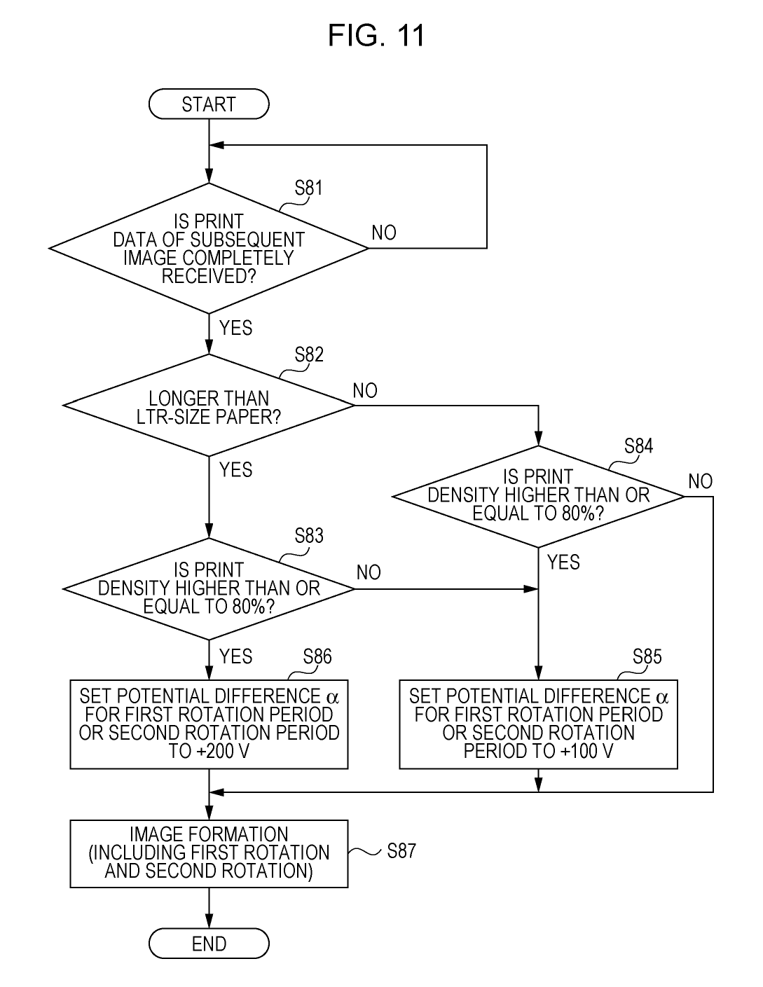

Similar to the first embodiment, in order to estimate the risk of a reduced image density occurring at the trailing-end side of the image, which can occur due to decreased toner in the foam layer, a sequence that uses the number of print dots as an indicator and a sequence that uses the length of a transfer medium and the print density as indicators will now be described with reference to flow charts shown in FIGS. 10 and 11.

### Sequence Using the Number of Print Dots as Indicator (FIG. 10)

When the sequence commences, it is determined in step S71 whether print data of a subsequent image is completely received. In step S72, it is determined whether the number of print dots A for each image of a print job is greater than or equal to the number of print dots A1 corresponding to 80% of the print density of letter-size paper. If greater than or equal to the value A1, the process proceeds to step S73. If smaller than the value A1, the process proceeds to step S74. In step S73, a potential difference α between the shaft 2a and the shaft 1a for the first rotation period or the second rotation period is set to +100 V. In step S74, image forming operation (including first rotation and second rotation) is carried out.

### Sequence Using Length of Transfer Medium and Print Density as Indicators (FIG. 11)

When the sequence commences, it is determined in step S81 whether print data of a subsequent image is completely received. In step S82, it is determined whether the length of a transfer medium for each image of a print job is greater than the length of letter-size paper. If longer than letter-size paper, the process proceeds to step S83. If shorter than or the same length as letter-size paper, the process proceeds to step S84. In step S83, it is determined whether the print density of each image of the print job is higher than or equal to 80%. If higher than or equal to 80%, the process proceeds to step S86. If lower than 80%, the process proceeds to step S85. In step S84, it is determined whether the print density of each image of the print job is higher than or equal to 80%. If higher than or equal to 80%, the process proceeds to step S85. If lower than 80%, the process proceeds to step S87. In step S85, the potential difference α between the shaft 2a and the shaft 1a for the first rotation period or the second rotation period is set to +100 V. In step S86, the potential difference α between the shaft 2a and the shaft 1a for the first rotation period or the second rotation period is set to +200 V. In step S87, image forming operation (including first rotation and second rotation) is carried out.

Similar to the third embodiment, the fourth embodiment can advantageously reduce the risk of a reduced image density occurring at the trailing-end side of the image and can also soak the supplying roller 2 with the toner within a shorter time due to the bias application. In particular, the following advantages can be achieved when the first rotation period is extended and when the second rotation period is extended.

The control for extending the first rotation period is performed so that the supplying roller 2 can hold a sufficient amount of toner. Thus, for example, the effect of a decreased amount of toner held in the foam layer occurring with printing operation prior to performing printing on banner paper can be cancelled, and the supplying roller 2 can hold a sufficient amount of toner prior to the printing operation to be performed on banner paper, thereby reducing the risk of a reduced image density occurring in the image forming operation to be performed immediately after the first rotation.

Regarding the control for extending the second rotation period, because the amount of toner in the foam layer is decreased upon completion of the printing operation performed on, for example, banner paper, the control is performed so that the foam layer is sufficiently soaked with toner during the second rotation. Thus, the risk of a reduced image density occurring in the image forming operation to be performed on letter-size paper immediately after the printing operation performed on, for example, banner paper can be reduced.

Although the aforementioned risk can be effectively reduced by using the number of print dots as a single indicator since the number of print dots is substantially proportional to the amount of toner required for developing an image, as shown in the sequence in FIG. 10, the single indicator may alternatively be combined with another indicator, as in FIG. 11. Although a predetermined value is used as a reference for determining whether to apply a voltage for soaking the supplying roller 2 with the toner in this embodiment, the value is changeable where appropriate depending on the embodiment. Furthermore, although the print density and the length of the transfer medium in the conveying direction for forming a single image are used as the indicators for estimating the aforementioned risk in this embodiment, the total length of the transfer medium in the conveying direction corresponding to multiple images or the overall print density of the multiple images may alternatively be used so that a long-term risk can be estimated and reduced. If it is determined that there is a risk of the occurrence of a reduced image density in the sequences in FIGS. 10 and 11 (i.e., when each indicator exceeds a corresponding threshold value), the bias application according to this embodiment and the extension of the first rotation period or the second rotation period according to the second embodiment may both be performed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-276831 filed Dec. 4, 2009, which is hereby incorporated by reference herein in its entirety.

What is claimed is:

1. An image forming apparatus comprising:
an image bearing member that bears an electrostatic latent image;
a toner bearing member that bears and transports a toner so as to supply the toner to the electrostatic latent image;
a toner supplying member having a foam layer on a surface thereof and configured to supply the toner to the toner bearing member, the toner being capable of entering and exiting the foam layer;
an arithmetic portion that counts the number of print dots on the basis of image information for forming the electrostatic latent image; and
an adjusting unit configured to adjust an amount of toner contained in the foam layer during a non-developing period, wherein when the number of print dots is greater than or equal to a threshold value, the adjusting unit performs adjustment so as to increase the amount of toner contained in the foam layer relative to when the number of print dots is smaller than the threshold value.

2. The image forming apparatus according to claim 1,
wherein the toner supplying member is provided in a rotatable manner, and
wherein the adjusting unit performs the adjustment to increase the amount of toner by extending a rotation time of the toner supplying member during the non-developing period.

3. The image forming apparatus according to claim 1,
wherein the toner bearing member includes a first electrode member,
wherein the toner supplying member includes a second electrode member,
wherein the foam layer is provided around the second electrode member, and
wherein the adjusting unit performs the adjustment to increase the amount of toner by controlling electric potentials of the first and second electrode members so that a value obtained by subtracting the electric potential of the first electrode member from the electric potential of the second electrode member has a polarity opposite of a normal charge polarity of the toner during the non-developing period.

4. The image forming apparatus according to claim 1, wherein the non-developing period is a period corresponding to a gap between a transfer medium and a subsequent transfer medium when continuous printing is performed.

5. The image forming apparatus according to claim 1, wherein the non-developing period is a period between a point at which the toner supplying member starts rotating and a point at which a developing process commences when image forming operation is performed, or is a period between a point at which the developing process is completed and a point at which the toner supplying member stops rotating.

6. An image forming apparatus comprising:
an image bearing member that bears an electrostatic latent image;
a toner bearing member that bears and transports a toner so as to supply the toner to the electrostatic latent image;
a toner supplying member having a foam layer on a surface thereof and configured to supply the toner to the toner bearing member, the toner being capable of entering and exiting the foam layer; and
an adjusting unit configured to adjust an amount of toner contained in the foam layer during a non-developing period, wherein when a length of a transfer medium in a conveying direction thereof is greater than or equal to a threshold value, the adjusting unit performs adjustment so as to increase the amount of toner relative to when the length of the transfer medium is smaller than the threshold value.

7. The image forming apparatus according to claim 6,
wherein the toner supplying member is provided in a rotatable manner, and
wherein the adjusting unit performs the adjustment to increase the amount of toner by extending a rotation time of the toner supplying member during the non-developing period.

8. The image forming apparatus according to claim 6,
wherein the toner bearing member includes a first electrode member,
wherein the toner supplying member includes a second electrode member,
wherein the foam layer is provided around the second electrode member, and
wherein the adjusting unit performs the adjustment to increase the amount of toner by controlling electric potentials of the first and second electrode members so that a value obtained by subtracting the electric potential of the first electrode member from the electric potential of the second electrode member has a polarity opposite of a normal charge polarity of the toner during the non-developing period.

9. The image forming apparatus according to claim 6, wherein the non-developing period is a period corresponding to a gap between a transfer medium and a subsequent transfer medium when continuous printing is performed.

10. The image forming apparatus according to claim 6, wherein the non-developing period is a period between a point at which the toner supplying member starts rotating and a point at which a developing process commences when image forming operation is performed, or is a period between a point at which the developing process is completed and a point at which the toner supplying member stops rotating.

11. An image forming apparatus comprising:
an image bearing member that bears an electrostatic latent image;
a toner bearing member that bears and transports a toner so as to supply the toner to the electrostatic latent image;
a toner supplying member having a foam layer on a surface thereof and configured to supply the toner to the toner bearing member, the toner being capable of entering and exiting the foam layer;
an arithmetic portion that calculates a print density, which is a proportion of the number of print dots occupying the number of dots in a printable region, on the basis of image information for forming the electrostatic latent image; and
an adjusting unit configured to adjust an amount of toner contained in the foam layer during a non-developing period, wherein when the print density calculated by the arithmetic portion is greater than or equal to a threshold value, the adjusting unit performs adjustment so as to increase the amount of toner relative to when the calculated print density is smaller than the threshold value.

12. The image forming apparatus according to claim 11, wherein when two conditions including the print density being greater than or equal to the threshold value and a length of a transfer medium in a conveying direction being greater than or equal to a threshold value are satisfied, the adjusting unit performs the adjustment to increase the amount of toner relative to when at least one of the two conditions is not satisfied.

13. The image forming apparatus according to claim 11,
wherein the toner supplying member is provided in a rotatable manner, and
wherein the adjusting unit performs the adjustment to increase the amount of toner by extending a rotation time of the toner supplying member during the non-developing period.

14. The image forming apparatus according to claim 11,
wherein the toner bearing member includes a first electrode member,
wherein the toner supplying member includes a second electrode member,
wherein the foam layer is provided around the second electrode member, and
wherein the adjusting unit performs the adjustment to increase the amount of toner by controlling electric potentials of the first and second electrode members so that a value obtained by subtracting the electric potential of the first electrode member from the electric potential of the second electrode member has a polarity opposite of a normal charge polarity of the toner during the non-developing period.

15. The image forming apparatus according to claim 11, wherein the non-developing period is a period corresponding to a gap between a transfer medium and a subsequent transfer medium when continuous printing is performed.

16. The image forming apparatus according to claim 11, wherein the non-developing period is a period between a point at which the toner supplying member starts rotating and a point at which a developing process commences when image forming operation is performed, or is a period between a point at which the developing process is completed and a point at which the toner supplying member stops rotating.
